(19) United States
(12) Patent Application Publication
(10) Pub. No.: US 2012/0134068 A1
(43) Pub. Date: May 31, 2012

(54) MULTILAYERED CERAMIC CAPACITOR

(75) Inventors: Eun Hyuk CHAE, Seongnam (KR); Dae Bok Oh, Seoul (KR); Kang Heon Hur, Seongnam (KR); Hae Suk Chung, Seoul (KR); Young Don Choi, Suwon (KR)

(73) Assignee: SAMSUNG ELECTRO-MECHANICS CO., LTD.

(21) Appl. No.: 13/283,858

(22) Filed: Oct. 28, 2011

(30) Foreign Application Priority Data
Nov. 29, 2010 (KR) 10-2010-0119776

(51) Int. Cl. H01G 4/12

(52) U.S. Cl. 361/321.2

(57) ABSTRACT

In a multilayered ceramic capacitor, the width of an exposed portion of an internal electrode is reduced to be narrower than that of a non-exposed portion thereof. A dummy electrode that is not electrically connected to the internal electrode is formed to be connected to an external electrode. Deterioration of reliability due to penetration of the plating solution thereby is prevented and reduction in adhesion of the external electrode due to reduction in width of the exposed portion of the internal electrode is supplemented through mechanical connection between the external electrode and the dummy electrode.

### CROSS-REFERENCE TO RELATED APPLICATIONS

This application claims the priority of Korean Patent Application No. 10-2010-0119776 filed on Nov. 29, 2010, in the Korean Intellectual Property Office, the disclosure of which is incorporated herein by reference.

### BACKGROUND OF THE INVENTION

1. Field of the Invention

The present invention relates to a multilayered ceramic capacitor, and more particularly, to a multilayered ceramic capacitor having excellent reliability and excellent external electrode adhesion.

2. Description of the Related Art

In accordance with the recent trend towards compact and multi-functional electronic devices, the demand for a multilayered capacitor having a compact size and a high capacitance has been increased. In order to manufacture the capacitor having the compact size and the high capacitance, ceramic layers should be thinned or an area of internal electrodes facing each other (hereinafter, a facing area) should be increased. When the ceramic layers are thinned, insulation resistance and withstand voltage are reduced. Therefore, there is a limitation in reducing a thickness of the ceramic layers. In addition, when the facing area of the internal electrodes is increased, an area of the internal electrode exposed to the outside of a ceramic body is increased, thereby causing the deterioration of reliability after plating.

Internal electrodes of a multilayered ceramic capacitor are divided into first and second internal electrodes, and the first and second internal electrodes are alternately stacked in a zigzag form. The first and second internal electrodes have exposed portions exposed to the surface of a ceramic body, and voltages of opposite polarities are applied thereto via external electrodes, respectively. Capacitance is formed in a dielectric layer between the first and second internal electrodes.

In order to increase the capacitance of the multilayered ceramic capacitor, the width of the internal electrodes is increased to increase the facing area of the internal electrodes. According to this method, when the widths of the internal electrodes are increased, the widths of the internal electrodes exposed to the outside are also increased, a plating solution is infiltrated into the multilayered ceramic capacitor through pores of the external electrodes at the time of plating, and internal resistance (IR) is deteriorated by the infiltrated plating solution after the plating, thereby deteriorating the reliability of the multilayered ceramic capacitor.

### SUMMARY OF THE INVENTION

An aspect of the present invention provides a multilayered ceramic capacitor having improved reliability and improved external electrode adhesion.

According to an aspect of the present invention, there is provided a multi-layered ceramic capacitor, including: a ceramic body having a plurality of dielectric layers stacked therein; internal electrodes formed on the dielectric layers and each configured of an exposed portion exposed to one surface of the ceramic body and a non-exposed portion having a width wider than that of the exposed portion; dummy electrodes formed on the dielectric layer to be spaced apart by a predetermined interval from the exposed portion of the internal electrode, a length of an exposed portion of the dummy electrode exposed to one surface of the ceramic body being larger than a difference between a width of the non-exposed portion of the internal electrode and a width of the exposed portion of the internal electrode; and an external electrode (not shown) formed on a surface of the ceramic body and electrically connected to the internal electrode and the dummy electrode.

The exposed portions of the dummy electrodes may be formed to be extended from one surface of the ceramic body to the other surface thereof.

A plane shape of the dummy electrodes may have an ‘L’ shape or a polygonal shape.

The number of dummy electrodes may be two or more.

The dummy electrodes may be formed to the left and the right of the exposed portion of the internal electrodes.

The external electrode may be formed to cover the entirety of the exposed portion of the dummy electrodes.

According to another aspect of the present invention, there is provided a multi-layered ceramic capacitor, including: a ceramic body having a plurality of dielectric layers stacked therein; first and second internal electrodes formed on the dielectric layer and configured of at least two exposed portions exposed to one surface of the ceramic body and a non-exposed portion having a width wider than that of the exposed portions; first and second dummy electrodes formed on the dielectric layer to be spaced apart by a predetermined interval from the first and second internal electrodes; and an external electrode formed on a surface of the ceramic body and electrically connected to the internal electrodes and the dummy electrodes.

The first and second dummy electrodes may be formed to the left and the right of the first and second internal electrodes.

The exposed portion of the first dummy electrode may be formed to be extended from one surface of the ceramic body to the other surface thereof.

A plane shape of the first and second dummy electrodes may have an ‘L’ shape or a polygonal shape.

The number of the first and second dummy electrodes may be 2 or more.

The external electrode may be formed to cover the entirety of the exposed portion of the dummy electrode.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are views showing patterns of internal electrodes according to an exemplary embodiment of the present invention; and

FIGS. 3 and 4 are views showing patterns of internal electrodes according to another exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

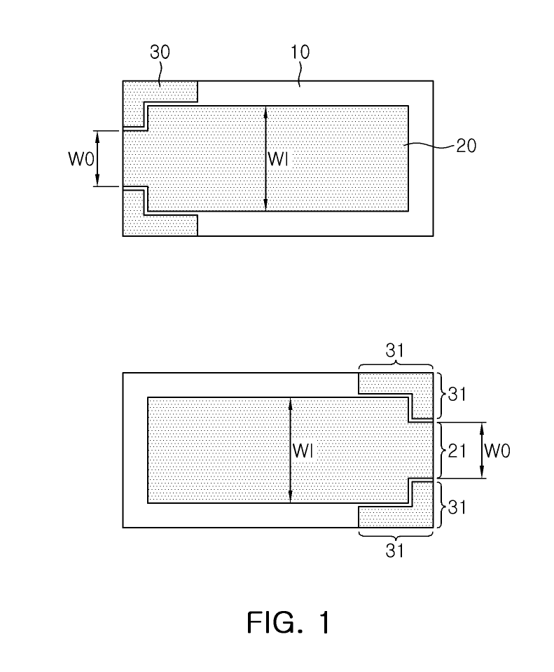

FIG. 1 shows patterns of internal electrodes according to an exemplary embodiment of the present invention. A multilayered ceramic capacitor according to the exemplary embodiment of the present invention includes: a ceramic body having a plurality of dielectric layers 10 stacked therein; internal electrodes 20 each formed on the plurality of dielectric layers 10 and configured to have an exposed portion 21 exposed to one surface of the ceramic body and a non-exposed portion having a width wider than that of the exposed portion; dummy electrodes 30 formed on the dielectric layer 10 to be spaced apart from the exposed portion 21 of the internal electrode by a predetermined interval, a length of an exposed portion 31 of the dummy electrode 30 exposed to one surface of the ceramic body being larger than a difference between a width WI of the non-exposed portion of the internal electrode 21 and a width WO of the exposed portion of the internal electrode 21; and external electrodes (not shown) formed on a surface of the ceramic body and electrically connected to the internal electrode 20 and the dummy electrode 30.

Generally, the multilayered ceramic capacitor is manufactured by stacking the dielectric layers 10 each having the internal electrode 20 formed thereon, compressing, cutting and sintering the stack to manufacture the ceramic body, and forming external electrodes on the surface of the ceramic body. The dielectric layer 10 is manufactured of a dielectric material slurry by a doctor blade method, or the like, and the internal electrode 20 is printed on the surface of the dielectric layer 10.

When an area of the internal electrode 20 is increased in order to increase capacitance of the multilayered ceramic capacitor, the width WO of a portion (hereinafter, referred to as the ‘exposed portion 21’) of the internal electrode 20 exposed to the surface of the ceramic body is also increased, thereby causing a deterioration in performance due to the infiltration of a plating solution. In order to solve this deterioration problem, there has been used a method of increasing the width WI of a portion (hereinafter, referred to as the ‘non-exposed portion’ of the internal electrode 20 which is not exposed to the surface of the ceramic body, while reducing the width WO of the exposed portion 21 of the internal electrode 20, that is, a method of forming the internal electrode 20 such that the width WO of the exposed portion of the internal electrode 20 is smaller than the width WI of the non-exposed portion of the internal electrode.

However, the smaller the width WO of the exposed portion 21 of the internal electrode 20, the weaker the strength with which the external electrode is stuck to the ceramic body. The external electrode is electrically and mechanically connected to the internal electrode 20 through the exposed portion 21 of the internal electrode 20. As the width WO of the exposed portion 21 of the internal electrode 20 becomes wider, a contact area of the internal electrode 20 and the external electrode is increased to increase the adhesion with which the external electrode is stuck to the ceramic body. On the other hand, when the width WO of the exposed portion 21 of the internal electrode is small, the adhesion with which the external electrode is stuck to the ceramic body is reduced.

In order to supplement a reduction in a length of a connecting portion between the internal electrode 20 and the external electrode due to the reduction in the width WO of the exposed portion 21 of the internal electrode, the dummy electrode 30 that is not electrically and mechanically connected to the internal electrode 20 is introduced. The dummy electrode 30 is formed at a margin of the ceramic body and has a portion exposed to the surface of the ceramic body. Hereinafter, a portion exposed to the surface of the ceramic body of the dummy electrode 30 will be referred to as the ‘exposed portion 31 of the dummy electrode’. The dummy electrode 30 does not contribute to forming the capacitance in the capacitor. The non-exposed portion of the internal electrode 20 contributes to forming the capacitance, however.

The length of the exposed portion 31 of the dummy electrode should be larger than the difference between the width WI of the non-exposed portion of the internal electrode 21 and the width WO of the exposed portion of the internal electrode 21. This is because the dummy electrode 30 is introduced in order to supplement the reduced width WO of the exposed portion 21 of the internal electrode. According to this exemplary embodiment of the present invention, the width WO of the exposed portion 21 of the internal electrode is smaller than the width WI of the non-exposed portion thereof, as shown in FIG. 1. The width of the connecting portion at which the external electrode and the internal electrode 20 are mechanically connected to each other is reduced, and thereby lowering the adhesion with which the external electrode is stuck to the ceramic body. Therefore, the dummy electrode 30 is additionally formed at the margin of the ceramic body to mechanically connect the external electrode to the dummy electrode 30, whereby the adhesion adhesion with which the external electrode is stuck to the ceramic body may not be lowered but also increased. Therefore, the width of the exposed portion 31 of the dummy electrode should be larger than the reduced amount of the width WO of the exposed portion 21 of the internal electrode.

The exposed portion 31 of the dummy electrode may be extended from one surface of the ceramic body to the other surface thereof. The exposed portion 31 of the dummy electrode may be formed on the surface of the ceramic body in which the exposed portion 21 of the internal electrode exists. However, the present invention is not limited thereto. When the exposed portion 31 of the dummy electrode is formed to be extended from one surface of the ceramic body to the other surface thereof, the adhesion with which the external electrode is stuck to the ceramic body is more excellent. This is because the length of the exposed portion 31 of the dummy electrode may be further increased by a length of the exposed portion 31 of the dummy electrode extended to the other surface to increase a contact length between the dummy electrode and the external electrode, thereby improving the adhesion with which the external electrode is stuck to the ceramic body. In geometrical aspects, the reason for the increase in the adhesion with which the external electrode is stuck to the ceramic body is that ‘L’ shape or an angled shape (i.e., a shape with an angle), which the exposed portion 31 of the dummy electrode has, has a greater ability to withstand external force.

In addition, since the dummy electrode 30 is electrically separated from the internal electrode 20, the internal electrode 20 and the dummy electrode 30 should be disposed to be spaced apart from each other. While a smaller spaced distance between the dummy electrode 30 and the internal electrode 20 is preferable, the spaced distance between the dummy electrode 30 and the internal electrode 20 is appropriately determined in consideration of a manufacturing process, electrical characteristics, yield, and the like.

A pattern shape of the dummy electrode 30 may have an ‘L’ shape or a polygonal shape. As described above, in the case in which the exposed portion 31 of the dummy electrode is formed to be extended from one surface of the ceramic body to the other surface thereof, the pattern of the dummy electrode 30 formed at the margin of the dielectric layer may also have the L shape. In addition, so long as the dummy electrode 30 does not electrically contact the internal electrode 20, it may have a triangular shape, a rectangular shape, a pentagonal shape, or the like.

The dummy electrode 30 may be integrally formed in a body as described above, but the dummy electrode 30 may be also formed by divided pattern of several dummy electrodes. For example, the dummy electrode 30 may be formed on a surface in which the exposed portion 21 of the internal electrode exists and may also be separately formed on the other surface, in the ceramic body. That is, at least two dummy electrodes may also be formed. The number of dummy electrodes 30 is not specifically limited.

The dummy electrode may be formed to the left and the right of the exposed portion of the internal electrode. In addition, the external electrode may be connected to the dummy electrode 30 and be formed to completely cover the entirety of the exposed portion 31 of the dummy electrode. This is because the dummy electrode 30 is formed in order to prevent the lowering of the adhesion with which the external electrode is stuck to the ceramic body caused by the reduction in the length of the connecting portion of the internal electrode 20 and the external electrode due to the reduction in the width WO of the exposed portion 21 of the internal electrode. Thereby, mechanical strength may be maximized.

As for the external electrode, external electrodes are each formed on the surface of the ceramic body using paste, and are each electrically and mechanically connected to the exposed portion 21 of each internal electrode and the exposed portion 31 of each dummy electrode. In detail, external voltage having opposite polarities is applied to the respective internal electrodes 20 through the external electrodes, and the capacitance is formed between the internal electrodes 20 that are alternately stacked. The adhesion with which the external electrode is stuck to the ceramic body depends on the width WO of the exposed portion 21 of the internal electrode 21 and the width of the exposed portion 31 of the dummy electrode mechanically connected to the external electrode. Accordingly, in order to improve the adhesion with which the external electrode is stuck to the ceramic body, the sum of the width WO of the exposed portions 21 of the internal electrodes 21 and the width of the exposed portions 31 of the dummy electrodes should be larger than the width WI of the non-exposed portions of the internal electrodes.

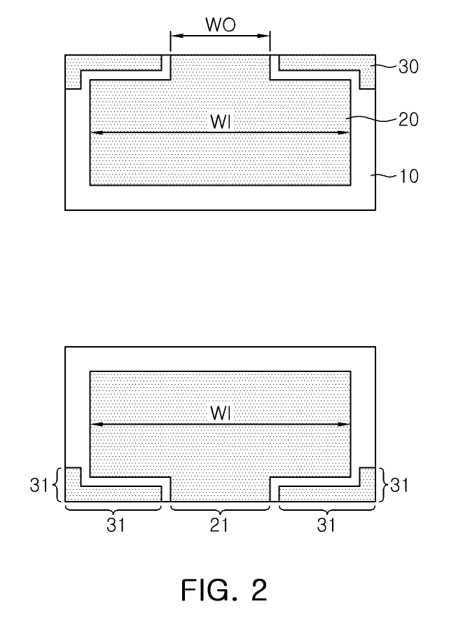

FIG. 2 shows a pattern of an internal electrode 20 according to the exemplary embodiment of the present invention, and is the same as FIG. 1 except that a reverse-type internal electrode 20 is applied thereto. When the cross-section of the ceramic body is viewed from the top, it has a rectangular shape. An internal electrode in a form in which the exposed portion 21 of the internal electrode is formed toward a long side of the rectangle will be referred to as the reverse-type internal electrode 20. While the exposed portion 21 of the internal electrode is formed toward a short side of the rectangle as shown in FIG. 1 in a general case, the exposed portion 21 of the internal electrode is formed toward the long side of the rectangle in FIG. 2.

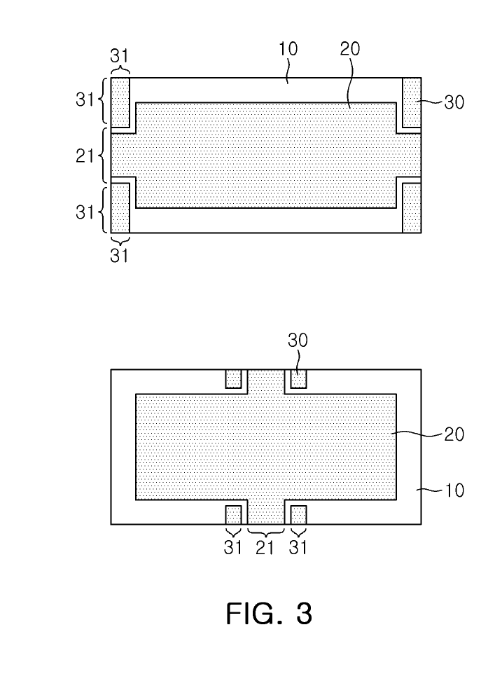

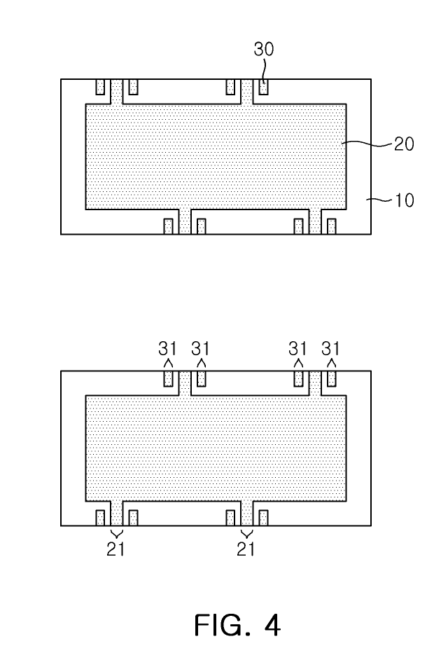

FIGS. 3 and 4 show a pattern of an internal electrode according to another exemplary embodiment of the present invention. Hereinafter, the points different from the first exemplary embodiment of the present invention will mainly be described.

A multilayered ceramic capacitor according to this exemplary embodiment of the present invention includes: a ceramic body having a plurality of dielectric layers stacked therein; first and second internal electrodes formed on the dielectric layers and each configured of at least two exposed portion exposed to the surfaces of the ceramic body and a non-exposed portion having a width wider than that of the exposed portions; first and second dummy electrodes formed on the dielectric layers to be spaced apart by a predetermined interval from the first and second internal electrodes, respectively; and external electrodes formed on the surfaces of the ceramic body and electrically connected to the internal electrodes and the dummy electrodes, respectively.

In the multilayered ceramic capacitor, the internal electrodes may be divided into the first and second internal electrodes. The first and second internal electrodes are alternately stacked in a zigzag form. In the case of a two-terminal multilayered ceramic capacitor, each of the first and second internal electrodes has a single exposed portion, and the respective exposed portions of the first and second internal electrodes are exposed to the opposing surfaces of the ceramic body. However, in the case of a multi-terminal multilayered ceramic capacitor, each of the first and second internal electrodes has at least two exposed portions. The dummy electrode formed near the first internal electrode is referred to as the first dummy electrode, and the dummy electrode formed near the second internal electrode is referred to as the second dummy electrode.

FIG. 3 shows a case in which the internal electrode is a feed through type internal electrode. The feed through type internal electrode indicates an internal electrode formed to penetrate through the dielectric layer. That is, considering one the first internal electrode and one the second internal electrode, the number of exposed portions of the first and the second internal electrodes exposed to one surface of the ceramic body is one. When the internal electrode exposed to one surface of the ceramic body is the first internal electrode, a width of an exposed portion of the first dummy electrode may be wider than the difference between a width of the non-exposed portion of the first internal electrode and a width of the exposed portion thereof. Accordingly, a contact of the external electrode to the exposed portion of the first internal electrode and the exposed portion of the first dummy electrode is increased, whereby the adhesion with which the external electrode is stuck to the ceramic body may be increased. The first internal electrode and the first dummy electrode may have similar characteristics to the first exemplary embodiment of the present invention.

The second internal electrode is also formed to penetrate the dielectric layer. The penetration direction of the second internal electrode is perpendicular to that of the first internal electrode. However, in the second internal electrode, the width of the second dummy electrode may not be wider than the difference between a width of the non-exposed portion of the second internal electrode and a width of the exposed portion thereof. The width of the dummy electrode may be enlarged only under the limitation that the external electrodes are to be spaced from each other. This is because two exposed portions are formed in each of the first and second internal electrodes and thus a total of four exposed portions exist, such that four external electrodes should be formed to be spaced from each other.

The first and second dummy electrodes may be formed to the left and the right of the first and second internal electrodes. In addition, the exposed portion of the first dummy electrode may be extended from one surface of the ceramic body to the other surface thereof. In addition, first and second dummy electrodes may have an ‘L’ shape or a polygonal shape. Further, the number of the first and second dummy electrodes is 2 or more. Furthermore, the external electrode may be formed to cover the entirety of the exposed portion of the dummy electrode.

FIG. 4 shows a case in which, considering one the first internal electrode and one the second internal electrode, the number of exposed portions of the first and the second internal electrodes exposed to one surface of the ceramic body is four. Four exposed portions are formed in each of the first and second internal electrodes, a total of eight terminals are formed in the multilayered capacitor.

In this case, since the number of exposed portions of the internal electrode exposed to one surface of the ceramic body is two or more, the sum of the width of the exposed portion 31 of the dummy electrode and the width WO of the exposed portion 21 of the internal electrode may not be made to be wider than the width WI of the non-exposed portion of the internal electrode in order to improve reliability of the multilayered ceramic capacitor and improve the adhesion with which the external electrode is stuck to the ceramic body. The length of the exposed portion 31 of the dummy electrode may be formed to be long only under the limitation that the external electrodes are to be spaced by a predetermined distance from each other.

Hereinafter, the present invention will be described in detail with reference to Inventive and Comparative Examples. However, a scope of the present invention is not limited to Inventive example.

### INVENTIVE EXAMPLE

A multilayered ceramic capacitor used as Inventive Example was manufactured as follows. A pattern of an internal electrode having an exposed portion and a non-exposed portion having a width wider than that of the exposed portion was formed on a dielectric layer. Then, dummy electrodes having an ‘L’ shape were formed, on the dielectric layer, to the left and right sides of the exposed portion of the internal electrode so as to be spaced by a predetermined interval therefrom. In addition, the exposed portion of each of the dummy electrodes was extended from one surface of the ceramic body to the other surface thereof and a length of the dummy electrode was formed to be larger than a difference between the width of the non-exposed portion of the internal electrode and the width of the exposed portion thereof. Then, an external electrode completely covering the internal electrode and the dummy electrode and electrically connected to the internal electrode and the dummy electrode was formed on the surface of the ceramic body.

### COMPARATIVE EXAMPLE

A multilayered ceramic capacitor used as a Comparative Example was manufactured as follows. A pattern of an internal electrode having an exposed portion and a non-exposed portion having the same width as that of the exposed portion was formed on a dielectric layer. Then, an external electrode completely covering the exposed portion of the internal electrode and electrically connected to the internal electrode was formed on a surface of a ceramic body. A difference between Inventive and Comparative Examples is whether or not the dummy electrode exists.

Test results of the reliability of the adhesion with which the external electrode is stuck to the ceramic body for each of the multilayered ceramic capacitors manufactured according to Inventive and Comparative Examples are shown in Table 1. All conditions are the same for the tests in Inventive and Comparative Examples.

TABLE 1

| | Comparative | |
|---|---|---|
| | Example | Inventive Example |
| Adhesion of External | 1120 | 1260 |
| Electrode (gf) | | |
| Reliability (Error | 3.8 | 1.3 |
| Rate, %) | | |

It may be confirmed from Table 1 that since the adhesion of the external electrode according to Inventive Example, which is 1260 gf, is larger than that of the external electrode according to Comparative Example, which is 1120 gf, the adhesion of the external electrode according to Inventive Example is improved. In addition, it may be confirmed from Table 1 that since the error rate according to Inventive Example, which at 1.3% is smaller than that according to Comparative Example, 3.8%, the reliability according to Inventive Example is improved.

As set forth above, according to the exemplary embodiments of the present invention, the multi-layered ceramic capacitor may be prevented from being impaired in reliability due to the deterioration of the internal resistance caused by the infiltration of the plating solution through a pore of the external electrode at the time of plating.

In addition, the adhesion of the external electrode of the multi-layered ceramic capacitor may be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. A multi-layered ceramic capacitor, comprising:
a ceramic body having a plurality of dielectric layers stacked therein;
internal electrodes formed on the dielectric layers and each configured of a exposed portion exposed to one surface of the ceramic body and a non-exposed portion having a width wider than that of the exposed portion;
dummy electrodes formed on the dielectric layer to be spaced apart by a predetermined interval from the exposed portion of the internal electrode, a length of a exposed portion of the dummy electrode exposed to one surface of the ceramic body being larger than a difference between a width of the non-exposed portion of the internal electrode and a width of the exposed portion of the internal electrode; and
an external electrode formed on a surface of the ceramic body and electrically connected to the internal electrode and the dummy electrode.

2. The multi-layered ceramic capacitor of claim 1, wherein the exposed portions of the dummy electrodes are formed to be extended from one surface of the ceramic body to the other surface thereof.

3. The multi-layered ceramic capacitor of claim 1, wherein a plane shape of the dummy electrodes is a ‘L’ shape or a polygonal shape.

4. The multi-layered ceramic capacitor of claim 1, wherein the number of dummy electrodes is two or more.

5. The multi-layered ceramic capacitor of claim 1, wherein the dummy electrodes are formed to the left and the right of the exposed portion of the internal electrodes.

6. The multi-layered ceramic capacitor of claim 1, wherein the external electrode is formed to cover the entirety of the exposed portion of the dummy electrodes.

7. A multi-layered ceramic capacitor, comprising:
a ceramic body a plurality of dielectric layers stacked therein;
first and second internal electrodes formed on the dielectric layers and each configured of at least two exposed portions exposed to one surface of the ceramic body and a non-exposed portion having a width wider than that of the exposed portions;
first and second dummy electrodes formed on the respective dielectric layers to be spaced apart by a predetermined interval from the first and second internal electrodes, respectively; and
an external electrode formed on a surface of the ceramic body and electrically connected to the internal electrodes and the dummy electrodes.

8. The multi-layered ceramic capacitor of claim 7, wherein the first and second dummy electrodes are formed to the left and the right of the first and second internal electrodes.

9. The multi-layered ceramic capacitor of claim 7, wherein the exposed portion of the first dummy electrode is formed to be extended from one surface of the ceramic body to the other surface thereof.

10. The multi-layered ceramic capacitor of claim 7, wherein a plane shape of the first and second dummy electrodes is a ‘L’ shape or a polygonal shape.

11. The multi-layered ceramic capacitor of claim 7, wherein the number of the first and second dummy electrodes is 2 or more.

12. The multi-layered ceramic capacitor of claim 7, wherein the external electrode is formed to cover the entirety of the exposed portion of the dummy electrode.
